(19) United States
(12) Patent Application Publication
(10) Pub. No.: US 2026/0177948 A1
(43) Pub. Date: Jun. 25, 2026

(54) ELECTROPHOTOGRAPHIC ROTATING MEMBER AND ELECTROPHOTOGRAPHIC IMAGE FORMING APPARATUS

(71) Applicant: CANON KABUSHIKI KAISHA, Tokyo (JP)

(72) Inventors: MASATSUGU TOYONORI, Kanagawa (JP); YASUTOMO TSUJI, Saitama (JP); NAOKO KASAI, Kanagawa (JP)

(21) Appl. No.: 19/425,185

(22) Filed: Dec. 18, 2025

(30) Foreign Application Priority Data
Dec. 25, 2024 (JP) 2024-228920

(51) Int. Cl. G03G 15/16; G01N 21/55; G03G 15/00; G03G 15/01

(52) U.S. Cl. CPC G03G 15/162; G01N 21/55; G03G 15/5058; G01N 2021/555; G03G 15/0131; G03G 15/0189

(57) ABSTRACT

An electrophotographic rotating member having a surface layer, wherein on an outer surface of the surface layer, there exist a plurality of grooves which extend in an approximate rotation direction of the electrophotographic rotating member and which are formed to be regularly aligned in a specific direction, and a plurality of specific depressions, average spacing of the plurality of grooves is 2.0 to 10.0 μm, the depressions exist so as to notch walls sandwiching the grooves so that a part of the walls form an arc shape when viewed from a side of the outer surface of the electrophotographic rotating member, an average diameter of specific circles is 0.5 to 4.5 μm, an average value of distances of closest approach between centers of the plurality of drawn circles is in a specific range, and assuming there is no notch formed by the depressions, the walls extend in a specific direction.

### BACKGROUND

### Field of the Technology

The present disclosure relates to an electrophotographic rotating member such as a transport transfer belt or an intermediate transfer belt used in an electrophotographic image forming apparatus such as a copier, a printer, or the like, and to an electrophotographic image forming apparatus.

### Description of the Related Art

In an electrophotographic image forming apparatus, an electrophotographic belt is used as a transport transfer belt for transporting transfer material or as an intermediate transfer belt for temporarily transferring and holding a toner image. There is an image forming apparatus that cleans untransferred toner that could not be transferred to the electrophotographic belt by using a cleaning blade made of an elastic material such as urethane rubber. In recent years, to compete with other printing methods, there has been a trend toward enhancing the durability of electrophotographic image forming apparatuses from a cost-reduction perspective, and even as durability in terms of the number of printable sheets improves, electrophotographic members with superior toner cleaning characteristics are becoming increasingly necessary.

Japanese Patent Application Laid-open No. 2019-191511 discloses a technique for an image forming apparatus equipped with an intermediate transfer member so as to suppress wear on a belt and a cleaning blade and to stably remove transfer residual toner over a long period of time by configuring the intermediate transfer member to have a layer with a plurality of grooves formed thereon in a predetermined direction and setting an average spacing between adjacent grooves within a predetermined range.

In addition, in electrophotographic image forming apparatuses, in order to achieve high color reproducibility, a correction toner image is formed on an intermediate transfer belt, an optical sensor detects a correction image, and control of image forming conditions is performed based on the detection results. While doing so, the optical sensor detects the correction image by using reflected light from areas without toner and reflected light from the toner.

When a surface of an intermediate transfer member on which regular grooves are formed such as the intermediate transfer member described in Japanese Patent Application Laid-open No. 2019-191511 is irradiated with light from a light source of an optical sensor, diffraction occurs in the reflected light due to the grooves. The occurrence of diffracted light causes an amount of reflected light to significantly vary when the intermediate transfer member moves in a circumferential direction, thereby creating a problem in that detection accuracy of the correction image by the optical sensor declines.

On the other hand, in Japanese Patent Application Laid-open No. 2021-001954, intensity of diffracted light is reduced by providing grooves with regularly varying inter-groove spacing on a surface of an intermediate transfer member, thereby suppressing variations in sensor output within one revolution of the intermediate transfer member and improving the detection accuracy of a correction image by an optical sensor.

### SUMMARY

In Japanese Patent Application Laid-open No. 2021-001954, the detection accuracy of the correction image by the optical sensor is improved by regularly varying the spacing between the grooves. On the other hand, even in electrophotographic rotating members with constant inter-groove spacing, there is a need to reduce intensity of diffracted light and improve the detection accuracy of a correction image by an optical sensor.

The present inventors carried out further studies with reference to Japanese Patent Application Laid-open No. 2021-001954. During this process, the present inventors recognized that when the average groove spacing falls to 10.0 μm or less, the effect of diffracted light becomes significant, leading to a decrease in the detection accuracy of the correction image by the optical sensor.

An object of the present disclosure is to provide an electrophotographic rotary member having a surface layer, wherein the surface layer has grooves, and even when average spacing of the grooves is 10.0 μm or less, a variation in an amount of reflected light when rotationally driven is small, and toner cleaning characteristics remain excellent over a long period of time. Another object of the present disclosure is to provide an electrophotographic image forming apparatus having the electrophotographic rotating member.

One aspect of the present disclosure provides an electrophotographic rotating member having a surface layer, wherein on an outer surface of the surface layer, there exist a plurality of grooves which extend in an approximate rotation direction of the electrophotographic rotating member and which are formed to be regularly aligned in a direction orthogonal to the approximate rotation direction, and a plurality of depressions irregularly arranged, average spacing of the plurality of grooves is 2.0 to 10.0 μm, the depressions exist so as to notch walls sandwiching the grooves so that a part of the walls form an arc shape when viewed from a side of the outer surface of the electrophotographic rotating member, when drawing circles based on the arc shape of the walls notched by the depressions, an average diameter of the circles is 0.5 to 4.5 μm, an average value of distances of closest approach between centers of the plurality of drawn circles is greater than the average diameter of the circles and is not more than 10.0 μm, and assuming there is no notch formed by the depressions, the walls extend in the approximate rotation direction of the electrophotographic rotating member so as to maintain a width of the grooves constant.

Further, another aspect of the present disclosure provides An electrophotographic image forming apparatus, comprising: an image bearing member bearing a toner image; a movable intermediate transfer member onto which the toner image is transferred from the image bearing member; and an optical sensor which irradiates the intermediate transfer member with light and detects reflected light, wherein on an outer surface of the intermediate transfer member, there exist a plurality of grooves which extend in the movement direction of the intermediate transfer member and which are formed to be regularly aligned in a direction orthogonal to the movement direction of the intermediate transfer member, and a plurality of depressions irregularly arranged, average spacing of the plurality of grooves is 2.0 to 10.0 μm, the depressions exist so as to notch walls sandwiching the grooves so that a part of the walls form an arc shape when viewed from an outer surface side of the intermediate transfer member, when drawing circles based on the arc shape of the walls notched by the depressions, an average diameter of the circles is 0.5 to 4.5 μm, an average value of distances of closest approach between centers of the plurality of drawn circles is greater than the average diameter of the circles and is not more than 10.0 μm, and assuming there is no notch formed by the depressions, the walls extend in the movement direction of the intermediate transfer member so as to maintain a width of the grooves constant.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic views showing a configuration of an outer surface of an electrophotographic belt.

FIG. 2 is a schematic view showing a cross section in a direction orthogonal to a circumferential direction of the electrophotographic belt.

FIG. 3 is a schematic view showing a cross section in a direction orthogonal to the circumferential direction of the electrophotographic belt.

FIG. 4 is a schematic view showing an example of a configuration of an image forming apparatus adopting an intermediate transfer system.

FIG. 5 is a schematic view showing an example of a configuration of a density detection sensor.

FIGS. 6A and 6B are schematic views showing an example of an output variation of the density detection sensor.

FIG. 7 is an explanatory diagram of an evaluation result of angular distribution characteristics of reflected light in an electrophotographic belt having grooves.

FIG. 8 is a schematic view showing an example of a manufacturing method of an electrophotographic belt using a stretch blow molding machine.

FIG. 9 is a schematic view showing a configuration of an imprinting apparatus for forming grooves on a surface of an electrophotographic belt.

FIG. 10 is a schematic view showing a configuration of a convex pattern of a cylindrical mold.

FIGS. 11A and B are explanatory diagrams of a method of measuring a depression.

FIG. 12 is an explanatory diagram of a method of measuring a groove shape or a concave shape of a depression.

FIG. 13 is a schematic view showing a method of measuring a shape of an electrophotographic member.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

The present inventors carried out studies to obtain an electrophotographic rotating member that exhibits excellent toner cleaning characteristics over a long period of time and exhibits minimal variation in an amount of reflected light when rotationally driven. As a result, it was confirmed that by notching, in an arc shape, a part of walls sandwiching regularly arranged grooves by irregularly arranged depressions and disrupting the regular shape of the grooves, a peak intensity of diffracted light is weakened. Based on the above results, the present inventors concluded that disrupting the regular shape of the grooves could reduce fluctuations in the amount of reflected light in a rotational direction of the electrophotographic rotating member.

That is, the present disclosure relates to an electrophotographic rotating member having a surface layer, wherein on an outer surface of the surface layer, there exist a plurality of grooves which extend in an approximate rotation direction of the electrophotographic rotating member and which are formed to be regularly aligned in a direction orthogonal to the approximate rotation direction, and a plurality of depressions irregularly arranged, average spacing of the plurality of grooves is 2.0 to 10.0 μm, the depressions exist so as to notch walls sandwiching the grooves so that a part of the walls form an arc shape when viewed from a side of the outer surface of the electrophotographic rotating member, when drawing circles based on the arc shape of the walls notched by the depressions, an average diameter of the circles is 0.5 to 4.5 μm, an average value of distances of closest approach between centers of the plurality of drawn circles is greater than the average diameter of the circles and is not more than 10.0 μm, and assuming there is no notch formed by the depressions, the walls extend in the approximate rotation direction of the electrophotographic rotating member so as to maintain a width of the grooves constant.

Hereinafter, an electrophotographic belt as an electrophotographic rotating member according to an aspect of the present disclosure will be described in detail. Note that the present invention is not limited to the following examples.

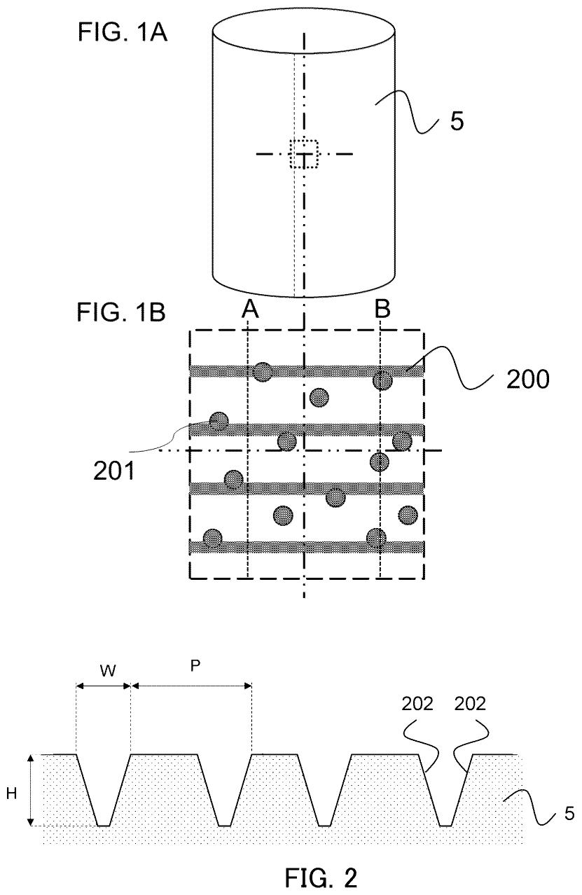

FIGS. 1A and 1B are schematic views showing a configuration of an outer circumferential surface (outer surface) of an electrophotographic belt.

### Electrophotographic Belt

In an electrophotographic belt 5 having a surface layer, there exist a plurality of grooves 200 and depressions 201, on an outer surface of the surface layer. The grooves 200 are provided so as to extend in a circumferential direction (rotation direction) of the electrophotographic belt 5. In FIG. 1B, the grooves 200 are regularly arranged at a constant width and constant spacing. Specifically, a plurality of grooves 200 formed to be regularly aligned in a direction orthogonal to the rotation direction is present on the outer surface of the surface layer. In addition, the surface layer has walls 202 that sandwich the grooves 200. Furthermore, in FIG. 1B, on the outer surface of the surface layer, portions other than the grooves 200 and other than the depressions 201 have a flat shape.

On the other hand, the plurality of depressions 201 are arranged irregularly. Specifically, a plurality of irregularly arranged depressions 201 are present on the outer surface of the surface layer. Due to the depressions 201, the walls 202 sandwiching the grooves 200 are notched such that, when viewed from the outer surface side of the electrophotographic belt, a portion of the walls 202 form an arc shape. As a result, the regular shape of the grooves is disrupted.

Furthermore, assuming there is no notch formed by the depressions 201, the walls 202 extend in the circumferential direction of the electrophotographic belt so as to maintain the width of the grooves 200 constant. Assuming there is no notch formed by the depressions 201 means, for example, assuming a state where, among the grooves 200 extending in the circumferential direction of the electrophotographic belt, a shape of the grooves 200 in a portion not notched by the depressions 201 extends in the circumferential direction of the electrophotographic belt 5 and the depressions 201 are not present.

FIG. 2 shows a sectional view of a portion that does not include the depressions 201 in the direction orthogonal to the circumferential direction of the electrophotographic belt 5 (in FIG. 1B, a dashed line A). In FIG. 2, W denotes a width of the grooves, H denotes a depth of the grooves, and P denotes spacing between grooves.

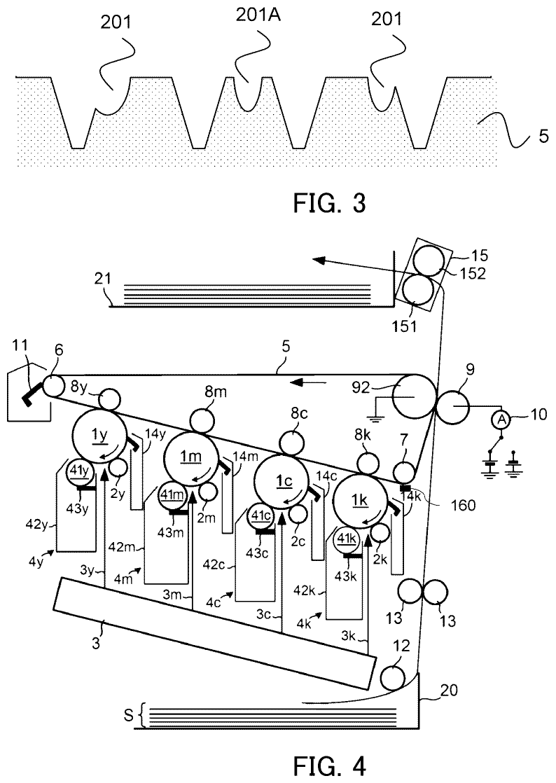

Next, FIG. 3 shows a sectional view of a portion that includes the depressions 201 in the direction orthogonal to the circumferential direction of the electrophotographic belt 5 (in FIG. 1B, a dashed line B). There is a portion where the regular shape of the grooves is disrupted by the depressions 201 and an opening width increases. FIG. 3 also shows a depression 201A not in contact with any groove. In this manner, due to the depressions 201, irregular concave shapes are present on the outer surface of the surface layer.

The grooves 200 are provided in plurality on the electrophotographic belt 5. From the perspective of enabling toner cleaning to be performed in a stable manner, the average spacing of the plurality of grooves 200 is 2.0 to 10.0 μm. The average spacing of the plurality of grooves 200 preferably is 3.0 to 10.0 μm and more preferably is 5.0 to 10.0 μm.

If the average spacing is wider than 10.0 μm, due to an increase in an area of the cleaning blade coming into contact with a portion not provided with the grooves, a friction force generated between the cleaning blade and the electrophotographic belt increases. As a result, when the electrophotographic belt is used over a long period of time, the cleaning blade wears down and cleaning characteristics are more likely to decline.

In addition, if the average spacing is narrower than 2.0 μm, the portion provided with grooves on the surface layer becomes excessive. As a result, undesirably, toner tends to accumulate in the grooves and a decline in transferability of toner in the grooves becomes more apparent.

An average value of the width (W) of the grooves 200 preferably is 0.1 to 3.0 μm, more preferably is 0.2 to 2.0 μm, and even more preferably is 0.5 to 2.0 μm. The average value of the width is preferably 0.1 μm or more because the possibility that the grooves will disappear due to wear of the surface of the electrophotographic belt decreases. The average value of the width is preferably 3.0 μm or less because toner becomes less likely to get stuck in the grooves, transferability of toner is less likely to decline, and a deterioration in image quality is less likely to become noticeable.

An average value of the depth (H) of the grooves 200 preferably is 0.1 to 5.0 μm and more preferably is 0.2 to 2.0 μm. The depth is preferably 0.1 μm or more because the possibility that the grooves will disappear due to wear of the surface of the electrophotographic belt decreases. The depth is preferably 5.0 μm or less because durability of the electrophotographic belt is more likely to improve.

The average spacing, the average value of width, and the average value of depth of the plurality of grooves 200 are measured by observing the grooves at 150× magnification using a laser microscope (model: VK-X200, manufactured by KEYENCE CORPORATION).

First, a reference plane of the electrophotographic belt is defined in a cross-sectional profile obtained by the laser microscope. Since the surface of the electrophotographic belt typically has a flat portion, the flat portion is set as a reference plane. There is a location on the cross-sectional profile where grooves are formed relative to the reference plane. This portion is defined as the grooves. Specifically, as shown in FIG. 12, a portion extending in an approximately circumferential direction of the electrophotographic belt and regularly aligned in a direction orthogonal to the approximately circumferential direction in a portion having a depth of 0.01 μm or more relative to the reference plane is defined as the grooves, and an area of the grooves is defined as the entire portion below the reference plane. A groove shape is a shape of a boundary between the grooves and the portion other than the grooves.

Measurements are taken at a total of 18 points: three points in the width direction and six points in the circumferential direction (rotation direction) of the electrophotographic belt. Measurements in the width direction are to be performed at positions of 0 mm and ±100 mm, with a center in the width direction of the width of the electrophotographic belt as the reference. The signs indicate a measurement position relative to the reference position. In other words, the position at −100 mm is point-symmetrical to the position at +100 mm, with the 0 mm position as the reference. In addition, the circumferential direction is measured at intervals of one-sixth of the circumferential length.

From the cross-sectional profile, ten or more groove shapes are measured per measurement point. Then, arithmetic mean values of the widths, depths, and spacing measured from all groove shapes at the total of 18 measurement points are used as the average value of the groove widths, the average value of the groove depths, and the average spacing between the plurality of grooves, respectively.

In FIGS. 1A and 1B, while the plurality of grooves 200 are formed so as to extend in the circumferential direction of the electrophotographic belt and regularly align in the direction orthogonal to the circumferential direction, the present disclosure is not limited to this aspect. For example, the direction in which the plurality of grooves extend may be the approximately circumferential direction (approximate rotation direction) of the electrophotographic belt. In addition, when the direction in which the plurality of grooves extend is considered a first direction, the plurality of grooves may be formed to be regularly aligned in a direction orthogonal to the first direction. Furthermore, assuming there is no notch formed by the depressions 201, the walls 202 may extend in the approximately circumferential direction of the electrophotographic belt so as to maintain the width of the grooves 200 constant.

In the present disclosure, the approximately circumferential direction (approximate rotation direction) is not particularly limited as long as toner cleaning characteristics are exhibited. For example, when the direction in which the plurality of grooves extend is considered a first direction and an angle formed between the first direction and the circumferential direction is 0° to 10°, the plurality of grooves can be described as extending in the approximately circumferential direction. The angle formed between the first direction and the circumferential direction preferably is 0° to 5° and more preferably is 0° to 1°.

Next, the depressions 201 will be described. The depressions 201 are provided in plurality on the electrophotographic belt 5. The depressions 201 are irregularly arranged on the surface of the electrophotographic belt 5. Specifically, a plurality of irregularly arranged depressions 201 are present on the outer surface of the surface layer. By notching the walls with the depressions 201 so that a portion of the walls sandwiching the grooves form an arc shape when viewed from the outer surface side of the electrophotographic belt 5, the intensity of diffracted light originating from the regularly arranged grooves 200 can be reduced. Depressions 201A not in contact with any groove may be present on the outer surface of the surface layer.

An average diameter of circles drawn based on the arc shape of the walls notched by the depressions (hereinafter, also referred to as an average diameter of depressions) is 0.5 to 4.5 μm from the perspective of enabling an amount of reflected light to be stably detected by an optical sensor. When the average diameter of the depressions is less than 0.5 μm, the diffracted light cannot be sufficiently reduced. When the average diameter of the depressions exceeds 4.5 μm, toner becomes embedded in the depressions and toner transferability declines. The average diameter of the depressions preferably is 1.0 to 4.5 μm and more preferably is 2.0 to 4.5 μm. A method of adjusting the average diameter of depressions will be described later.

When drawing circles based on the arc shape of the walls notched by the depressions 201, an average value of distances of closest approach between centers of the plurality of drawn circles is greater than the average diameter of the circles and is not more than 10.0 μm from the perspective of enabling an amount of reflected light to be stably detected by an optical sensor. In this case, the distance of closest approach between centers of the plurality of circles refers to, when drawing circles based on the arc shape of the walls notched by the depressions 201 and focusing on a center of a single circle among the drawn circles, a minimum value obtained by calculating distances to the centers of surrounding circles, respectively. In addition, hereinafter, the distance of closest approach between the centers of the plurality of circles is also referred to as a distance of closest approach between the depressions. A method of adjusting the average value of the distances of closest approach between depressions will be described later.

When the distance of closest approach between depressions is equal to the average diameter of the circles, the circles are in contact with each other. As a result, a state exists in which a regular shape is imparted by the depressions and the diffracted light cannot be sufficiently reduced. Alternatively, when the distance of closest approach exceeds 10 μm, the number of depressions decreases and the intensity of the diffracted light cannot be sufficiently reduced.

The average value of distances of closest approach between centers of the plurality of circles is preferably greater than the average diameter of the circles and is 9.0 μm or less, more preferably greater than the average diameter of the circles and is 7.0 μm or less, and even more preferably greater than the average diameter of the circles and is 6.0 μm or less.

The average value of distances of closest approach between centers of the plurality of circles is preferably a value that is 1.5 times the average diameter of the circles or more and more preferably a value that is 2.0 times the average diameter of the circles or more.

The average diameter of the depressions 201 and the average value of the distances of closest approach between the depressions are measured by observing the depressions at 150× magnification using a laser microscope (model: VK-X200, manufactured by KEYENCE CORPORATION). In this observation, shape image data is acquired, and a major axis, a minor axis, and a centroid (geometric center) of each depression within the observation field of view are evaluated.

A specific measurement method will be described.

First, a reference plane of the electrophotographic belt is defined in a cross-sectional profile obtained by the laser microscope. Since the surface of the electrophotographic belt typically has a flat portion, the flat portion is set as a reference plane. There is a location on the cross-sectional profile where depressions are formed relative to the reference plane. This portion is defined as the depressions. Specifically, as shown in FIG. 12, a portion other than the grooves in a portion having a depth of 0.01 μm or more relative to the reference plane is defined as the depressions, and an area of the depressions is defined as the entire portion below the reference plane. A concave shape of the depressions is a shape of a boundary between the depressions and the portion other than the depressions.

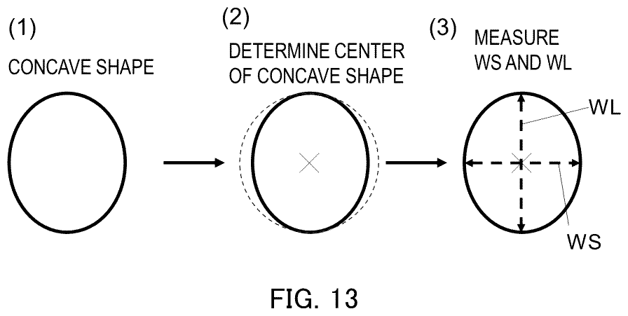

First, a centroid is determined with respect to one depression. A center of a smallest circumscribing circle among circumscribing circles that circumscribe the concave shape of the depression is defined as the centroid ((2) in FIG. 13). Among widths that pass through the centroid, a longest width reaching an end of the concave shape is defined as a major axis (WL) and a shortest width is defined as a minor axis (WS) ((3) in FIG. 13). In addition, a square root of a product of the major axis and the minor axis is defined as the diameter of the depression. The diameters of all of the depressions in the field of view are calculated, and an arithmetic mean of the diameters of all of the depressions is calculated and adopted as the average diameter of the depressions. In addition, centroid-to-centroid distances are calculated with respect to the depressions surrounding each depression, and a shortest centroid-to-centroid distance is defined as a distance of closest approach of each depression. Furthermore, the distances of closest approach between all of the depressions in the field of view are measured and an arithmetic mean is calculated.

The electrophotographic belt 5 is not particularly limited as long as the electrophotographic belt 5 has a surface layer. For example, the electrophotographic belt may have a base layer and may have an elastic layer on the base layer. The surface layer may be formed on the base layer or the surface layer may be formed on the elastic layer.

As a processing method of the base layer, known processing methods of a thermoplastic resin or known processing methods of a thermosetting resin can be used. As a processing method of a thermoplastic resin, for example, a resin composition can be pelletized and molded using known molding methods such as continuous melt extrusion molding, injection molding, stretch blow molding, or inflation molding to obtain a base layer. As a processing method of the elastic layer, a similar method to the processing method of the base layer can be used.

As a processing method of the surface layer, for example, the surface layer can be obtained by molding the surface layer on the base layer or the elastic layer using a known molding method such as dip coating, spray coating, flow coating, shower coating, roll coating, spin coating, or ring coating.

As a processing method for forming the grooves on the surface layer, for example, the grooves can be formed using a known processing method such as machining, etching, or imprinting. From the perspective of processing reproducibility and processing cost of the grooves, imprinting is preferable.

As a processing method for forming the depression, imprinting can be used. By imparting a convex shape for forming the grooves and the depressions to the imprint mold, the grooves and the depressions can be processed simultaneously. Changing the convex shape at this point enables the average diameter of the depressions and the average value of the distances of closest approach between depressions to be changed. Alternatively, imprinting may be performed with a mold for forming the depressions after forming the grooves. As another method, the processing method for the surface layer may be performed using a coating solution for the surface layer that has been prepared to form depressions in the surface layer.

Examples of a method of using a coating solution for the surface layer that has been prepared to form depressions in the surface layer include a method of using a coating solution containing hydrocarbon oil.

The depressions can be obtained by using a coating solution created by adding hydrocarbon oil to a resin-based coating containing, for example, acrylate or methacrylate. For example, the base layer is obtained using the method described above. Then, the coating solution is applied to the base layer and the solvent is evaporated. Subsequently, the hydrocarbon oil is removed by wiping off the coating that has been applied. Accordingly, the surface layer on which depressions are formed can be obtained.

The resin-based coating may contain resins or a polymerizable monomer for forming resins. When the resin-based coating contains a polymerizable monomer, the polymerizable monomer may be polymerized on the base layer by performing UV irradiation or the like at least before or after evaporation of the solvent. Hereinafter, at least one selected from the group consisting of resins and polymerizable monomers for forming resins will be referred to as a resin component.

Although a detailed mechanism is not fully understood, it is presumed that hydrocarbon oil dissolved in the solvent within the coating solution forms oil droplets on the coating surface as the solvent evaporates, and removing the hydrocarbon oil after the coating hardens results in the formation of depressions.

While a content of the hydrocarbon oil in the coating solution is not particularly limited, the content relative to 100 parts by mass of the resin component preferably is 3.0 to 18.0 parts by mass, more preferably is 4.0 to 15.0 parts by mass, even more preferably is 4.0 to 11.0 parts by mass, and particularly preferably is 4.0 to 6.0 parts by mass. Since a size of the depressions (diameter and depth of the circles) and the distance between the depressions (number of depressions) vary depending on the content of the hydrocarbon oil, the hydrocarbon oil content may be adjusted according to the desired size. However, when the content is within the range described above, it is easier to keep the average diameter of the depressions and the average value of the distances of closest approach between the depressions within a suitable range.

Although the hydrocarbon oil is not particularly limited, the hydrocarbon oil is preferably a liquid at room temperature (23 to 30° C.). In other words, a melting point of the hydrocarbon oil is preferably 30° C. or lower and more preferably 23° C. or lower.

Examples of the hydrocarbon oil include aliphatic compounds having 8 to 18 carbon atoms (preferably 10 to 18, more preferably 14 to 18). The aliphatic compounds are not particularly limited and they may be straight-chain, branched, or alicyclic. As aliphatic compounds, chain-type saturated hydrocarbon compounds are preferred.

The thickness of the electrophotographic belt 5 is preferably from 10 μm to 500 μm and particularly preferably from 30 μm to 150 μm.

In addition to being used as an electrophotographic belt, the electrophotographic rotating member may be wrapped around or coated onto a drum or a roll used as an electrophotographic member. In other words, for example, the electrophotographic rotating member may be an electrophotographic belt. In addition, the electrophotographic belt may be used as an intermediate transfer member. In other words, for example, the electrophotographic rotating member may be an intermediate transfer belt. While a shape of the electrophotographic belt is not particularly limited, an endless belt shape is preferable.

### Electrophotographic Image Forming Apparatus

FIG. 4 shows an example of an image forming apparatus which is mounted with an electrophotographic belt based on the present disclosure as an intermediate transfer member and which is configured as an electrophotographic apparatus.

The electrophotographic image forming apparatus has an image bearing member that bears a toner image, a movable intermediate transfer member onto which the toner image is transferred from the image bearing member, and an optical sensor that irradiates the intermediate transfer member with light and detects reflected light.

For example, the electrophotographic image forming apparatus has the electrophotographic rotating member described above as the intermediate transfer member. In this case, a rotation direction of the electrophotographic rotating member corresponds to a movement direction of the intermediate transfer member. Specifically, on an outer surface of the intermediate transfer member, there exist a plurality of grooves which extend in the movement direction of the intermediate transfer member and which are formed to be regularly aligned in a direction orthogonal to the movement direction of the intermediate transfer member, and a plurality of depressions irregularly arranged, average spacing of the plurality of grooves is 2.0 to 10.0 μm, the depressions exist so as to notch walls sandwiching the grooves so that a part of the walls form an arc shape when viewed from an outer surface side of the intermediate transfer member, when drawing circles based on the arc shape of the walls notched by the depressions, an average diameter of the circles is 0.5 to 4.5 μm, an average value of distances of closest approach between centers of the plurality of drawn circles is greater than the average diameter of the circles and is not more than 10.0 μm, and assuming there is no notch formed by the depressions, the walls extend in the movement direction of the intermediate transfer member so as to maintain a width of the grooves constant.

The image forming apparatus forms color images using toners of four colors represented by C (cyan), M (magenta), Y (yellow), and K (black) with respect to a recording medium S such as paper supplied from a paper feeding cassette 20. The image forming apparatus has an image forming station for each color arranged approximately horizontally. The image forming stations are provided with photosensitive drums 1c, 1m, 1y, and 1k, respectively. Here, adding the subscripts “c,” “m,” “y,” or “k” to a reference sign indicates which color image forming station a component bearing the reference sign belongs to.

The image forming apparatus is provided with a laser scanner 3 that is a laser optical unit, and from the laser scanner 3, laser beams 3c, 3m, 3y, and 3k corresponding to image signals of each color are emitted toward the respective photosensitive drums 1c, 1m, 1y, and 1k. Since all image forming stations share the same structure, here, the image forming station for the color K will be described.

A conductive roller 2k that is a contact charging apparatus, a developing device 4k, a conductive roller that is a primary transfer roller 8k, and a toner recovery blade 14k used to clean the photosensitive drum 1k are arranged so as to surround the photosensitive drum 1k. The developing device 4k is provided with a developing roller 41k that is a developing material bearing member for developing a latent image on the photosensitive drum 1k, a developer container 42k that holds toner to be supplied to the developing roller 41k, and a developing blade 43k that restricts a toner amount on the developing roller 41k and imparts a charge.

The electrophotographic belt 5 is configured as an endless belt and commonly provided for each color image forming station, stretched over a secondary transfer opposing roller 92, a tension roller 6, and a driver roller 7, and rotates in a direction indicated by an arrow due to the driver roller 7. In a section between the tension roller 6 and the driver roller 7, the electrophotographic belt 5 sequentially comes into contact with surfaces of the photosensitive drums 1c, 1m, 1y, and 1k and is pressed toward the photosensitive drums 1c, 1m, 1y, and 1k by primary transfer rollers 8c, 8m, 8y, and 8k. Accordingly, the toner images formed on the surfaces of the photosensitive drums 1c, 1m, 1y, and 1k are to be transferred to the surface of the electrophotographic belt 5 that is the intermediate transfer member.

A secondary transfer roller 9 is provided so as to oppose the opposing roller 92, and the electrophotographic belt 5 is pressed toward the opposing roller 92 by the secondary transfer roller 9. A secondary transfer voltage is applied to the secondary transfer roller 9 from a power supply via a current detecting circuit 10. The secondary transfer roller 9 and the opposing roller 92 constitute a secondary transfer portion.

By passing through a nip portion constituted of the electrophotographic belt 5 and the secondary transfer roller 9 at the position of the opposing roller 92 via a feeding roller 12 and a transport roller 13, the toner image held on the outer circumferential surface of the electrophotographic belt 5 is to be transferred to the recording medium S. Accordingly, an image is formed on a surface of the recording medium S.

As the recording medium S to which the toner image has been transferred passes through a fixing unit 15 made up of a roller pair constituting a heating roller 151 and a pressure roller 152, the image is fixed and the recording medium S is discharged to a paper discharge tray 21.

A cleaning blade 11 that comes into contact with the outer circumferential surface of the electrophotographic belt 5 is provided at the position of the tension roller 6. Toner remaining on the outer circumferential surface of the electrophotographic belt 5 without being transferred to the recording medium S is scraped off and removed by the cleaning blade 11. The cleaning blade 11 is a member extending in a direction that is approximately orthogonal to the movement direction of the electrophotographic belt 5.

While a material of the cleaning blade 11 is not particularly limited as long as the material is suitable for toner cleaning, examples of the material include urethane rubber, acrylic rubber, nitrile rubber, and EPDM rubber, and from the perspective of toner cleaning, urethane rubber is preferable.

A tinge of printed materials may vary depending on conditions such as a use environment of the image forming apparatus. Therefore, it is necessary to measure density as appropriate and provide feedback to a control mechanism within a main body. A toner image for density correction is transferred to the surface of the electrophotographic belt 5 and then transported to the position of the driver roller 7 as the electrophotographic belt 5 rotates. The toner density is detected by a density detection sensor 160 positioned on the opposite side to the driver roller 7 with respect to the electrophotographic belt 5.

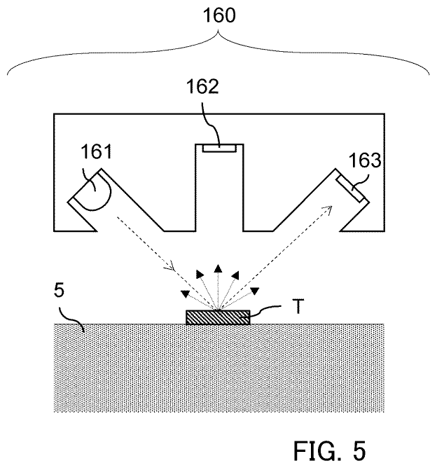

FIG. 5 is a schematic configuration diagram of the density detection sensor (optical sensor) 160. The density detection sensor 160 is constituted of a light emitting element 161, a specular reflection light receiving element 163, and a diffuse reflection light receiving element 162. The light emitting element 161 emits infrared light and the light is reflected by a surface of a toner image T. The specular reflection light receiving element 163 is arranged in a specular reflection direction with respect to the position of the toner image T and detects specular reflection light at the position of the toner image T. The diffuse reflection light receiving element 162 is arranged at a position other than the specular reflection direction with respect to the toner image T and detects diffuse reflection light at the position of the toner image T. Detected voltage values are referred to as a specular reflection output and diffuse reflection output, respectively.

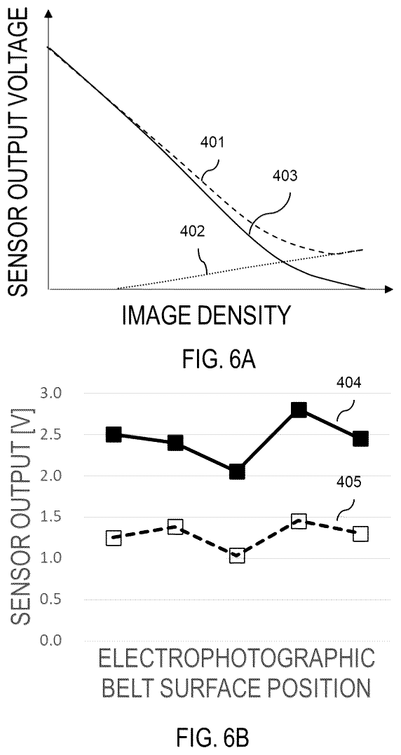

FIG. 6A is a schematic explanatory diagram illustrating a specular reflection output variation 401 and a diffuse reflection output variation 402 relative to image density, as well as a sensor output variation 403 calculated from the specular reflection output variation 401 and the diffuse reflection output variation 402.

When the amount of toner is small, the specular reflection output increases because more reflection is detected from the surface of the electrophotographic belt 5 that has a smooth mirror-like surface. As the amount of toner increases, the specular reflection output decreases. As the amount of toner increases and a toner layer count reaches one layer or more, the specular reflection component from the surface of the electrophotographic belt 5 virtually disappears. However, since the specular reflection output includes a diffuse reflection component in addition to a specular reflection component, the specular reflection output does not decrease monotonically in areas of high density.

On the other hand, the diffuse reflection output increases monotonically according to the amount of toner. However, a variation amount is small compared to the specular reflection output. The sensor output variation 403 correlated with image density is obtained by subtracting the diffuse reflection component obtained based on the diffuse reflection output from the specular reflection output (hereinafter referred to as a sensor output).

FIG. 6B is a schematic explanatory diagram of foundation outputs 404 at a plurality of locations of the electrophotographic belt 5 and patch outputs 405 at the positions. A foundation output refers to the sensor output in a state where toner is not present while a patch output refers to the sensor output in a state where toner is present.

As shown in FIG. 6B, the foundation outputs 404 vary depending on the position of the electrophotographic belt 5. Specifically, since there are localized differences in reflectivity and surface topography at the position of the electrophotographic belt 5, the specular reflection output varies. As a result, the foundation outputs 404 that are sensor outputs vary. The patch outputs 405 all represent detected toner images having been formed at a same halftone density. In addition, the patch outputs 405 vary depending on position in a similar manner to the foundation outputs 404. Therefore, controlling image density directly using patch outputs 405 causes the precision of image density control to decrease due to variations in the foundation outputs 404. Therefore, the specular reflection output that constitutes a main component of the foundation outputs is desirably uniform.

Variations in the specular reflection output occur due to the following causes. Specifically, reflectance characteristics from the surface of the electrophotographic belt 5 differ depending on the position of the electrophotographic belt 5 (in the belt circumferential direction and the belt width direction). In addition, with each revolution of the electrophotographic belt 5, the position of the electrophotographic belt 5 shifts slightly relative to a position irradiated with light by the light emitting element 161, due to a tolerance of an outer diameter of the driver roller 7, a tolerance of a circumferential length of the electrophotographic belt 5, a movement of the electrophotographic belt 5 in the belt width direction, and the like. This creates a difference in an amount of reflected light per revolution of the electrophotographic belt 5. Furthermore, variability in the reflectance characteristics from the surface of the electrophotographic belt 5 occurs because the intensity and the reflection angle of diffracted light differ depending on the position of the electrophotographic belt 5 (in the belt circumferential direction and the belt width direction) due to variability in the groove shape (groove spacing and depth) on the surface.

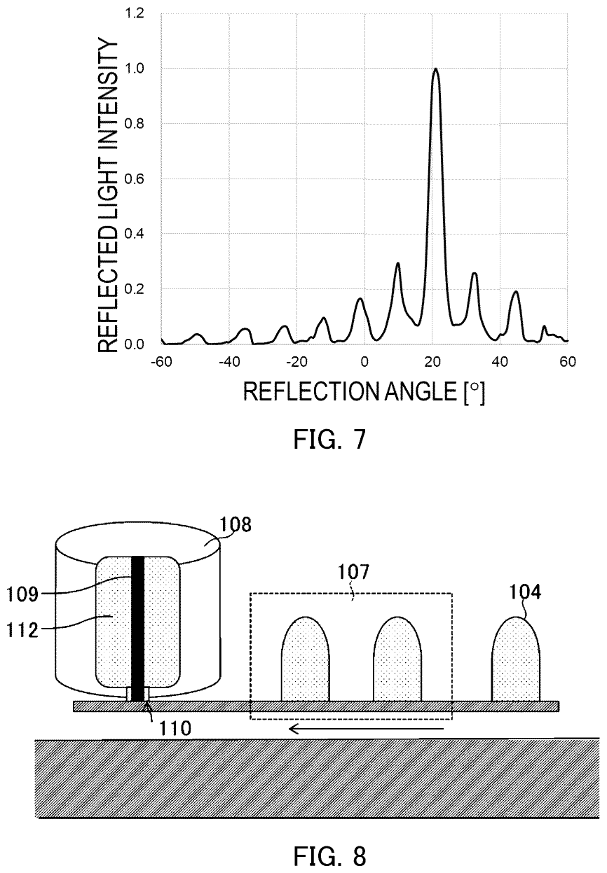

FIG. 7 shows a result of measuring angular distribution characteristics of reflected light from the electrophotographic belt with grooves formed on its surface at spacing of 3.5 μm, a width of 1.5 μm, and a depth of 0.5 μm. The present evaluation measures the angular distribution characteristics of reflected light when light with a wavelength λ of 622 nm is emitted at an angle of incidence of −20° and normalizes measurements based on peak values within the distribution. A peak at +20° originates from specular reflection light while peaks at +10° and +30° are peaks due to first order diffracted light. The occurrence of diffracted light may reduce the amount of reflected light received by the specular reflection light receiving element 163 or the diffracted light may inadvertently become mixed into the diffuse reflection light receiving element 162.

Therefore, it is necessary to minimize the intensity of diffracted light as much as possible. The electrophotographic belt according to the present disclosure is capable of suppressing the intensity of diffracted light.

### EXAMPLES

While the present disclosure will be described in specific terms by presenting examples and comparative examples below, it should be noted that the present disclosure is not limited thereto.

### Example 1

### Structure of Base Layer

First, a thermoplastic resin composition was prepared by hot-melt kneading the following base layer materials in a ratio of PEN/PEEA/CB=84/15/1 (mass ratio) using a twin-screw extruder (model: TEX30α, manufactured by The Japan Steel Works, Ltd.). A hot-melt kneading temperature was adjusted to fall within a range of 260° C. or higher and 280° C. or lower and a hot-melt kneading time was set at 3 to 5 minutes. The obtained thermoplastic resin composition was pelletized and dried at 140° C. for 6 hours.

### Base Layer Material

PEN: polyethylene naphthalate (trade name: TN-8050SC, manufactured by Teijin Chemicals Ltd.)
PEEA: polyether ester amide (trade name: PELESTAT NC6321, manufactured by Sanyo Chemical Industries, Ltd.)
CB: carbon black (trade name: MA-100, manufactured by Mitsubishi Chemical Corporation)

Next, the dried pellet-shaped thermoplastic resin composition was fed into an injection molding apparatus (model: SE180D, manufactured by Sumitomo Heavy Industries, Ltd.). Then, with a cylinder set temperature at 295° C., injection molding was performed into a mold maintained at 30° C. to fabricate a preform. The obtained preform had a test tube shape with an outer diameter of 50 mm, an inner diameter of 46 mm, and a length of 100 mm.

Next, the preform described above was biaxially stretched using a biaxial stretching apparatus (stretch blow molding machine) shown in FIG. 8. Prior to the biaxial stretching, a preform 104 was arranged inside a heating apparatus 107 equipped with a non-contact heater (not illustrated) for heating outer and inner walls of the preform 104, and the preform was heated by the heater until its outer surface temperature reached 150° C.

Next, the heated preform 104 was arranged inside a blow mold 108 that was maintained at a mold temperature of 30° C., and stretched axially using a stretching rod 109. At the same time, air conditioned to 23° C. was introduced into the preform 104 through a blow air injection portion 110 and the preform 104 was stretched in a radial direction. In this manner, a bottle-shaped molded article 112 was obtained.

Next, a barrel section of the obtained bottle-shaped molded article 112 was cut to obtain a base layer of a seamless electrophotographic belt. A thickness of the base layer of the electrophotographic belt was 70.2 μm, a circumferential length thereof was 712.2 mm, and a width thereof was 244.0 mm.

### Preparation of Coating Solution

In the present example, in order to suppress the effect of diffracted light originating from grooves formed so as to be regularly aligned on the outer surface of the electrophotographic belt 5 on the output of the density detection sensor 160, depressions are irregularly arranged on the outer surface of the electrophotographic belt 5.

In the present example, the depressions can be obtained by using a coating solution created by adding hydrocarbon oil to a coating containing UV-curable acrylate. Although a detailed mechanism is not fully understood, it is presumed that hydrocarbon oil dissolved in the solvent within the coating solution forms oil droplets on the coating surface as the solvent vaporizes, and removing the hydrocarbon oil after the coating hardens results in the formation of circular depressions.

Since hydrocarbon oils should preferably be a liquid under coating conditions or, in other words, at room temperature (23 to 30° C.), hydrocarbon oils with a melting point at or below room temperature are desirably used. In the present example, hexadecane with a melting point of 18 degrees was used.

The following surface layer materials were weighed in the ratio of AN/PTFE/GF/SL/IRG/HD=64/19/1/12/1/3 (only SL is expressed as a mass ratio based on solid content), and a solution was prepared by performing coarse dispersion processing on the materials excluding SL. In addition, dispersion of the obtained solution was performed using a high-pressure emulsifying disperser (model: Nanovator, manufactured by YOSHIDA KIKAI CO., LTD.). This dispersion processing was carried out until a 50% average particle size of the PTFE contained in the solution reached 200 nm.

While further stirring the SL, the solution from the completed dispersion processing was dripped and, finally, methyl ethyl ketone (MEK) was added as a diluent solvent at a ratio of 30 parts by mass to 100 parts by mass of the solution, yielding a coating solution for forming the surface layer. The particle size of the PTFE in the coating solution was measured using a high-concentration particle size analyzer (model: FPAR-1000, manufactured by Otsuka Electronics Co., Ltd.) based on dynamic light scattering (DLS) technology (ISO-DIS 22412).
AN: Dipentaerythritol penta acrylate and dipentaerythritol hexa acrylate (trade name: ARONIX M-402, manufactured by Toagosei Co., Ltd.)
PTFE: PTFE particles (trade name: Lubron L-5, manufactured by Daikin Industries, Ltd.)
GF: PTFE particle dispersant (trade name: GF-400, manufactured by Toagosei Co., Ltd.)
SL: Zinc antimonate particle slurry (trade name: Celnax CX-Z400K, manufactured by Nissan Chemical Corporation, containing 40% by mass of zinc antimonate particles)
IRG: Photopolymerization initiator (trade name: Omnirad 907, manufactured by IGM Resins B.V.)
HD: Hexadecane (manufactured by Fujifilm Wako Pure Chemical Corporation)

### Formation of Surface Layer and Depressions

The base layer obtained by blow molding was fitted onto the outer circumference of a cylindrical mold (circumferential length 712 mm) and ends were sealed. Then, the mold was immersed into a container filled with the coating solution for forming the surface layer, and by raising the mold so that the relative velocity between the liquid surface of the curable composition and the base layer remained constant, a coating film constituted of the coating solution was formed on the surface of the base layer. A withdrawal speed (relative speed between the liquid surface of the curable composition and the base layer) and the solvent ratio of the curable composition can be adjusted according to the required film thickness. In the present example, the withdrawal speed was set to 10 to 50 mm/s and adjusted so that the film thickness of the surface layer reached 3 μm.

In the present example, a coating direction refers to a direction opposite to a withdrawal direction of the base layer. In other words, a point where the base layer is first withdrawn from the coating solution becomes the most upstream point in the coating direction.

The base layer coated by the coating solution was removed from the cylindrical mold and dried for one minute at 23° C. under exhaust conditions. A drying temperature and a drying time were adjusted appropriately based on a solvent type, a solvent ratio, and the film thickness. Subsequently, a UV irradiator (model: UE06/81-3, manufactured by EYE GRAPHICS COMPANY) was used to irradiate the coating film with ultraviolet light until the cumulative light dose reached 600 mJ/cm², thereby curing the coating film.

By wiping off the coating film with a nonwoven fabric impregnated with MEK, a surface layer with irregularly distributed depressions was formed.

The sizes of the depressions and the distances of closest approach between the depressions were measured by observing the depressions at 150× magnification using a laser microscope (model: VK-X200, manufactured by KEYENCE CORPORATION). In this observation, shape image data is acquired, and a major axis, a minor axis, and a centroid (geometric center) of each depression within the observation field of view were evaluated.

A specific measurement method will be described. First, a centroid is determined with respect to one depression. A center of a smallest circumscribing circle among circumscribing circles that circumscribe the concave shape of the depression was defined as the centroid. Among widths that pass through the centroid, a longest width reaching an end of the concave shape was defined as a major axis and a shortest width was defined as a minor axis. In addition, a square root of a product of the major axis and the minor axis was defined as the diameter of the depression. The diameters of all of the depressions in the field of view were calculated, and an arithmetic mean of the diameters of all of the depressions was calculated and adopted as the average diameter of the depressions. In addition, centroid-to-centroid distances were calculated with respect to the depressions surrounding each depression, and a shortest centroid-to-centroid distance was defined as a distance of closest approach of each depression. Furthermore, the distances of closest approach between all of the depressions in the field of view were measured and an arithmetic mean was calculated.

An average diameter d of the depressions obtained by the present evaluation method was 1.8 μm, and an average value D of the distances of closest approach was 6.2 μm.

In addition, the thickness of the surface layer was determined by a destructive test in which an electrophotographic belt prepared separately under the same conditions was cut and its cross-section was observed using an electron microscope (model: XL30-SFEG, manufactured by FEI Company Japan Ltd.). The destructive test revealed that the thickness of the surface layer was 3.0 μm.

### Formation of Grooves

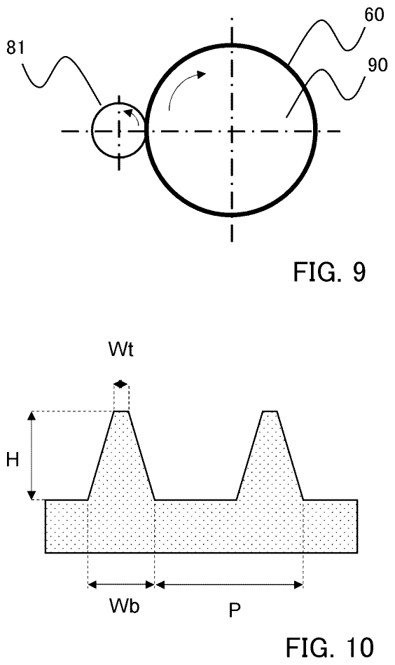

Grooves were formed on the surface layer using an imprinting apparatus shown in FIG. 9.

The imprinting apparatus is constituted of a cylindrical mold 81 and a cylindrical belt holding mold 90, wherein the cylindrical mold 81 can be pressed against the cylindrical belt holding mold 90 while maintaining their respective axes parallel. In this case, the cylindrical mold 81 and the cylindrical belt holding mold 90 rotate synchronously without slipping. In the present example, the cylindrical mold 81 is a mold made of carbon steel with electroless nickel plating, measuring 50 mm in diameter and 250 mm in length. A fine convex pattern is formed on the surface of the cylindrical mold 81 in a spiral shape with an angle of 0.1° relative to the circumferential direction of the cylindrical mold.

The convex pattern of the cylindrical mold used in the present example has a shape shown in FIG. 10, with respective dimensions being H=3.5 μm, Wb=1.8 μm, Wt=0.8 μm, and P=3.8 μm. A cartridge heater is embedded in the cylindrical mold 81 and heating can be performed.

A base layer 60 on which a surface layer had been formed was pre-fitted to an outer circumference of the cylindrical belt holding mold 90 (circumferential length 712 mm). The cylindrical belt holding mold 90 was rotated at a peripheral speed of 1 mm/sec together with the cylindrical mold 81 (in opposite directions), and while maintaining respective axial centerlines parallel to each other, the cylindrical mold 81 having been heated to 130° C. was brought into contact with the cylindrical belt holding mold 90, a load was increased at a rate of 1.0 kN/sec, and pressure was applied until 8.0 kN. Subsequently, while maintaining the load at 8.0 kN, the cylindrical belt holding mold 90 and the cylindrical mold 81 were rotated, and at a timing when the portion where the cylindrical belt holding mold 90 started to come into contact with the cylindrical mold 81 had passed one full circumference of the cylindrical belt holding mold 90, the load on the cylindrical mold 81 was reduced at a rate of 1.0 kN/s, thereby separating the cylindrical mold 81. Accordingly, grooves were formed by transferring the convex pattern of the cylindrical mold 81 onto the surface layer.

Evaluation methods for characteristic values and performance of the electrophotographic belt fabricated in the present example are as described in [Evaluation 1] to [Evaluation 4] below.

### [Evaluation 1] Evaluation of Groove Shape and Depressions Shape of Surface of Electrophotographic Belt

The grooves and depressions present on the outer surface of the electrophotographic belt were observed using a laser microscope (model: VK-X200, manufactured by KEYENCE CORPORATION) at a magnification of 150× and the spacing, the width, and the depth of the grooves, the diameter of the depressions, and the distances of closest approach were measured.

Measurements of the shapes were taken at a total of 18 points: three points in the width direction and six points in the circumferential direction (rotation direction) of the electrophotographic belt. Measurements in the width direction were performed at positions of 0 mm and ±100 mm, with a center in the width direction of the electrophotographic belt as the reference. The signs indicate a coating direction of the coating solution relative to the reference position, with an upstream side in the coating direction being positive and a downstream side in the coating direction being negative. Specifically, for example, “+100 mm” refers to a point 100 mm upstream in the coating direction of the coating solution from the center in the width direction of the electrophotographic belt. In addition, the circumferential direction was measured at intervals of one-sixth of the circumferential length. The evaluation was performed with observation positions in the circumferential direction being based on a processing start position of the electrophotographic belt and a direction of groove processing being a positive direction.

The spacing, width, and depth of the grooves are measured with respect to ten or more groove shapes per measurement point from the cross-sectional profile. In addition, arithmetic mean values of the widths, depths, and spacing measured from all groove shapes at the total of 18 measurement points were used as the average value of the groove widths, the average value of the groove depths, and the average spacing between the plurality of grooves, respectively. The average value of the widths, the average value of the depths, and average spacing of the grooves were W=1.0 μm, H=0.5 μm, and P=3.8 μm, respectively.

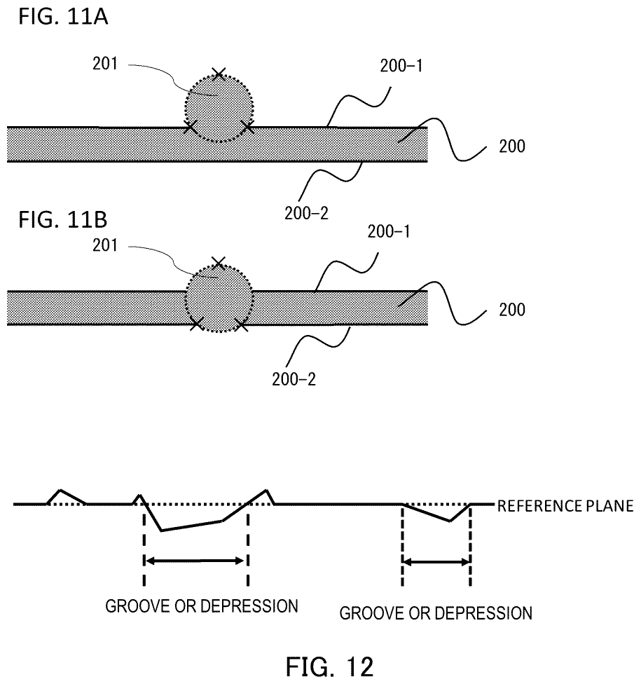

Sizes and distances of closest approach of the depressions of the electrophotographic belt with grooves formed by imprinting were evaluated using the following method. Depressions not intersecting with the grooves were evaluated in a same manner as before imprinting. In addition, the depressions intersecting with the grooves will be explained using FIGS. 11A and 11B.

As shown in FIG. 11A, when an edge of the depression 201 intersects only one of a first edge portion 200-1 and a second edge portion 200-2 that constitute the groove 200, the depression 201 was evaluated as follows. A center of a circle passing through three points including two points where the edge portion of the groove 200 intersects the edge of the depression 201 and one point that is farthest from a line forming the edge portion of the groove 200 on the edge of the depression 201 was defined as the centroid. In addition, a diameter of the circle was evaluated as the diameter of the depression.

Furthermore, as shown in FIG. 11B, when the edge of the depression 201 intersects both the first edge portion 200-1 and the second edge portion 200-2 that constitute the groove 200, the depression 201 was evaluated as follows. A center of a circle passing through three points including among a point that is farthest from a line forming a first edge portion 201-1 and a point that is farthest from a line forming a second edge portion 201-2 on the edge of the depression 201, one point that is farther from the line, and two points at which an opposite-side edge portion as viewed from the one point among the first edge portion 200-1 and the second edge portion 200-2 that constitute the groove 200 intersects with the edge of the depression was defined as the centroid. In addition, a diameter of the circle was evaluated as the diameter of the depression.

The average diameter d of the depressions and the average value D of the distances of closest approach were d=1.8 μm and D=6.2 μm, respectively, and it was confirmed that they did not change before and after the imprinting.

### [Evaluation 2] Evaluation of Reflected Light Angular Characteristics

To understand a generation status of diffracted light from the surface of the electrophotographic belt, angular distribution characteristics of reflected light from the electrophotographic belt were measured. Evaluation of the angular distribution characteristics of reflected light was performed according to the following procedure.

The angular distribution characteristics of reflected light when light with a wavelength λ of 622 nm is emitted at an angle of incidence of −20° was measured using Mini-Diff V1 manufactured by Synopsys, Inc. and the measurement was normalized based on peak values within the distribution. In the present evaluation, centered on the specular reflection light with a reflection angle of +20°, a peak intensity of the first order diffracted light was measured and ranked according to the following criteria.
Rank A: Peak intensity of first order diffracted light is 0.10 or less
Rank B: Peak intensity of first order diffracted light is more than 0.10 and 0.20 or less
Rank C: Peak intensity of first order diffracted light is more than 0.20

The reflected light angular characteristics of the electrophotographic belt according to present Example 1 was evaluated according to the evaluation method described above and the peak intensity of the first order diffracted light was 0.15. Based on the result, the electrophotographic belt according to Example 1 was determined to be Rank B.

### [Evaluation 3] Evaluation of Sensing

Using the electrophotographic image forming apparatus configured as shown in FIG. 4, an electrophotographic belt was mounted as an intermediate transfer medium, a specular reflectance output per revolution of the electrophotographic belt was measured in 1 mm increments, and an arithmetic mean value V_ave, a maximum value V_max, a minimum value V_min, and a fluctuation rate calculated from the following Equation (1) were evaluated.

Fluctuation rate (%)={(V_(max)−V_(min))/V_(ave)}×100 (1)

Note that the density detection sensor 160 of which a schematic configuration diagram is shown in FIG. 5 was used in the present evaluation. A specific configuration of the density detection sensor 160 is as follows.

An LED with a wavelength λ=840 nm was used as the light emitting element 161. The light emitting element 161, a specular reflection light sensor as the specular reflection light receiving element 163, and a diffusely reflected light sensor as the diffuse reflection light receiving element 162 were arranged so as to be aligned in the width direction of the electrophotographic belt. In addition, irradiation of the surface of the electrophotographic belt 5 is performed within a circular range approximately 2 mm in diameter (hereinafter referred to as a “spot diameter”) from a light emitting element angle of incidence of θi=−20°. Note that the “spot diameter” refers to the size of a detection range of the optical sensor on the electrophotographic belt 5 and, in this case, indicates the size of the detection range in the belt width direction. In addition, in the present evaluation, when the direction normal to the electrophotographic belt 5 and pointing toward the density detection sensor 160 is defined as 0°, the specular reflection light receiving element 163 is configured to receive reflected light from the electrophotographic belt 5 and the toner image T at an angle of +20°, while the diffuse reflection light receiving element 162 is configured to receive the same reflected light at an angle of 0°.

Note that the density detection sensor 160 is arranged at positions ±100 mm from the center in the width direction of the electrophotographic belt 5. Furthermore, since the specular reflection output varies depending on the conditions of the grooves and the depressions added to the surface of the electrophotographic belt, the present evaluation was performed after adjusting a light amount output so that the specular reflection output was 3.0 V at the starting point of the measurement. The fluctuation rates calculated using the method described above were ranked according to the following criteria.
Rank A: Fluctuation rate of 5% or less
Rank B: Fluctuation rate of more than 5% and 10% or less
Rank C: Fluctuation rate of more than 10%

Using the evaluation method described above, the sensing evaluation of the electrophotographic belt according to present Example 1 yielded a fluctuation rate of 8%, which was judged as Rank B.

### [Evaluation 4] Evaluation of Toner Cleaning Performance

Using the electrophotographic image forming apparatus configured as shown in FIG. 4, an electrophotographic belt was mounted as an intermediate transfer medium, and blade cleaning was performed while printing images to evaluate toner cleaning performance.

The evaluation was conducted under conditions of 15° C. temperature and 10% relative humidity, using JIS A4-size Extra paper (80 g/m² basis weight) manufactured by Oce Holding B.V. as the recording medium S, paper feeding was performed with 200,000 sheets as an upper limit in a two-sheet intermittent printing mode until toner cleaning was required, and the presence or absence of toner having passed through the cleaning blade was evaluated.

Specifically, first, with the secondary transfer voltage turned off (0 V), the photosensitive drums 1y and 1m were irradiated with laser beams 3y and 3m to record a red image (Y toner and M toner) across the entire A4 size surface. Subsequently, the secondary transfer voltage was set to an appropriate value and three blank sheets were fed continuously.

Since no secondary transfer voltage is applied, the Y toner and the M toner transferred from the photosensitive drums 1y and 1m to the entire surface of the electrophotographic belt 5 enter the cleaning blade 11 with almost none transferred to the recording medium S at the secondary transfer portion. If the entered toner is removed from the electrophotographic belt 5, the subsequent three sheets to be fed will be output as completely blank sheets. On the other hand, if the toner is not removed, the transfer residual toner having passed through the cleaning blade 11 will then be transferred to the recording medium S at the secondary transfer portion. In other words, the toner will be transferred onto blank paper and output onto the recording medium S as a faulty toner cleaning image.

The evaluation described above was performed after feeding 50,000 sheets, after feeding 100,000 sheets, after feeding 150,000 sheets, and after feeding 200,000 sheets. In addition, based on the evaluation results, the electrophotographic belts were ranked according to the following criteria.

When streaks parallel to the transport direction of the recording medium S were visually confirmed to have appeared on a blank area of the recording medium S, it was determined that faulty toner cleaning had occurred.
Rank A: Faulty toner cleaning did not occur after feeding 200,000 sheets.
Rank B: Faulty toner cleaning did not occur after feeding 150,000 sheets but faulty toner cleaning occurred after feeding 200,000 sheets.
Rank C: Faulty toner cleaning did not occur after feeding 100,000 sheets but faulty toner cleaning occurred after feeding 150,000 sheets.
Rank D: Faulty toner cleaning did not occur after feeding 50,000 sheets but faulty toner cleaning occurred after feeding 100,000 sheets.
Rank E: Faulty toner cleaning occurred after feeding 50,000 sheets.

Using the evaluation method described above, the toner cleaning characteristics of the electrophotographic belt according to present Example 1 were evaluated, whereby faulty toner cleaning did not occur after feeding 200,000 sheets and the electrophotographic belt was determined to be Rank A.

### Comparative Example 1

In preparing the surface layer material, an electrophotographic belt was fabricated in a similar manner to Example 1 with the exception of preparing the coating solution without using hexadecane, and it was confirmed that the surface contained no depressions and only grooves were formed. Evaluation results are shown in Table 1.

### Example 2

An electrophotographic belt was fabricated in a similar manner to Example 1 with the exception of setting groove spacing P to 10 μm in the convex pattern of the cylindrical mold, and the electrophotographic belt was evaluated. Evaluation results are shown in Table 1.

### Comparative Example 2

An electrophotographic belt was fabricated in a similar manner to Example 2 with the exception of using the coating solution used in Comparative Example 1, and the electrophotographic belt was evaluated. Evaluation results are shown in Table 1.

### Example 3

An electrophotographic belt was fabricated in a similar manner to Example 1 with the exception of changing the compounding ratio of the coating solution to AN/PTFE/GF/SL/IRG/HD=62/19/1/11/1/6 (only SL is expressed as a mass ratio based on solid content), and the electrophotographic belt was evaluated. Evaluation results are shown in Table 1.

### Example 4

An electrophotographic belt was fabricated in a similar manner to Example 2 with the exception of using the coating solution used in Example 3, and the electrophotographic belt was evaluated. Evaluation results are shown in Table 1.

### Example 5

An electrophotographic belt was fabricated in a similar manner to Example 1 with the exception of changing the compounding ratio of the coating solution to AN/PTFE/GF/SL/IRG/HD=65/20/1/12/1/1 (only SL is expressed as a mass ratio based on solid content), and the electrophotographic belt was evaluated. Evaluation results are shown in Table 1.

### Comparative Example 3

An electrophotographic belt was fabricated in a similar manner to Example 1 with the exception of changing the compounding ratio of the coating solution to AN/PTFE/GF/SL/IRG/HD=65.8/19.8/1.0/11.9/1.0/0.5 (only SL is expressed as a mass ratio based on solid content), and the electrophotographic belt was evaluated. Evaluation results are shown in Table 1.

### Comparative Example 4

An electrophotographic belt was fabricated in a similar manner to Comparative Example 1 with the exception of not forming grooves by imprinting, and the electrophotographic belt was evaluated. Evaluation results are shown in Table 1.

TABLE 1

| | | | | | | Depressions | | Evaluation result | | |
|---|---|---|---|---|---|---|---|---|---|---|
| | Surface layer material | | | | | | Average | | | Evaluation |
| | formulation | | | | | | value of | | Evaluation | of |
| | | Content | Grooves | | | Average | distances | Distribution | of amount | cleanability |
| | | (parts | Groove | Groove | | diameter of | of closest | of amount | of specular | after |
| Examples, | | by | spacing | width | Depth | depressions | approach | of reflected | reflection | durability |
| C.E. | Oil type | mass) | (P) | (W) | (H) | (d) | (D) | light | light | testing |
| Example 1 | Hexadecane | 5 | 3.8 μm | 1.0 μm | 0.5 μm | 1.8 μm | 6.2 μm | B | B | A |
| Example 2 | Hexadecane | 5 | 10.0 μm | 1.0 μm | 1.3 μm | 1.8 μm | 6.2 μm | A | A | B |
| Example 3 | Hexadecane | 10 | 3.8 μm | 1.0 μm | 0.5 μm | 2.5 μm | 5.2 μm | B | B | A |
| Example 4 | Hexadecane | 10 | 10.0 μm | 1.0 μm | 1.3 μm | 2.5 μm | 5.2 μm | A | A | A |
| Example 5 | Hexadecane | 2 | 3.8 μm | 1.0 μm | 0.5 μm | 1.3 μm | 8.8 μm | C | C | A |
| C.E. 1 | — | — | 3.8 μm | 1.0 μm | 0.5 μm | — | — | C | C | A |
| C.E. 2 | — | — | 10.0 μm | 1.0 μm | 1.3 μm | — | — | C | C | B |
| C.E. 3 | Hexadecane | 1 | 3.8 μm | 1.0 μm | 0.5 μm | 0.6 μm | 15.0 μm | C | C | A |
| C.E. 4 | — | — | — | — | — | — | — | A | A | D |

In the table, C.E. indicates Comparative Examples and the content indicates the amount of hydrocarbon oil per 100 parts by mass of the resin component in the coating solution.

As shown in Table 1, in Examples 1 to 5, the depressions are able to weaken the peak intensity of diffracted light by notching, in an arc shape, a part of the walls sandwiching the grooves, thereby disrupting the regularity of the groove shapes. Therefore, the fluctuation rate of specular reflection output was low and superior sensing characteristics were achieved.

On the other hand, in Comparative Examples 1 and 2, since the electrophotographic belt does not have depressions and the peak intensity of diffracted light is large, the fluctuation rate of specular reflection output increased. Therefore, sensing characteristics were poor.

In addition, in Comparative Example 3, while the depressions notch, in an arc shape, a part of the walls sandwiching the grooves, the average value of the distances of closest approach between the depressions is large. In other words, since the number of depressions is small, the depressions are unable to sufficiently weaken the peak intensity of the diffracted light. Therefore, the fluctuation rate of specular reflection output increased and sensing characteristics were poor.

According to an aspect of the present disclosure, an electrophotographic rotary member having a surface layer is provided, wherein the surface layer has grooves, and even when average spacing of the grooves is 10.0 μm or less, a variation in an amount of reflected light when rotationally driven is small, and toner cleaning characteristics remain excellent over a long period of time. According to another aspect of the present disclosure, an electrophotographic image forming apparatus having the electrophotographic rotating member is provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-228920, filed Dec. 25, 2024, which is hereby incorporated by reference herein in its entirety.

What is claimed is:

1. An electrophotographic rotating member having a surface layer, wherein
on an outer surface of the surface layer, there exist
a plurality of grooves which extend in an approximate rotation direction of the electrophotographic rotating member and which are formed to be regularly aligned in a direction orthogonal to the approximate rotation direction, and
a plurality of depressions irregularly arranged,
average spacing of the plurality of grooves is 2.0 to 10.0 μm,
the depressions exist so as to notch walls sandwiching the grooves so that a part of the walls form an arc shape when viewed from a side of the outer surface of the electrophotographic rotating member,
when drawing circles based on the arc shape of the walls notched by the depressions,
an average diameter of the circles is 0.5 to 4.5 μm,
an average value of distances of closest approach between centers of the plurality of drawn circles is greater than the average diameter of the circles and is not more than 10.0 μm, and
assuming there is no notch formed by the depressions, the walls extend in the approximate rotation direction of the electrophotographic rotating member so as to maintain a width of the grooves constant.

2. The electrophotographic rotating member according to claim 1, wherein an average value of widths of the grooves is 0.5 to 2.0 μm.

3. The electrophotographic rotating member according to claim 1, wherein the electrophotographic rotating member is an electrophotographic belt.

4. The electrophotographic rotating member according to claim 1, wherein the electrophotographic rotating member is an intermediate transfer belt.

5. An electrophotographic image forming apparatus, comprising:
an image bearing member bearing a toner image;
a movable intermediate transfer member onto which the toner image is transferred from the image bearing member; and
an optical sensor which irradiates the intermediate transfer member with light and detects reflected light, wherein
on an outer surface of the intermediate transfer member, there exist
a plurality of grooves which extend in the movement direction of the intermediate transfer member and which are formed to be regularly aligned in a direction orthogonal to the movement direction of the intermediate transfer member, and
a plurality of depressions irregularly arranged,
average spacing of the plurality of grooves is 2.0 to 10.0 μm,
the depressions exist so as to notch walls sandwiching the grooves so that a part of the walls form an arc shape when viewed from an outer surface side of the intermediate transfer member,
when drawing circles based on the arc shape of the walls notched by the depressions,
an average diameter of the circles is 0.5 to 4.5 μm,
an average value of distances of closest approach between centers of the plurality of drawn circles is greater than the average diameter of the circles and is not more than 10.0 μm, and
assuming there is no notch formed by the depressions, the walls extend in the movement direction of the intermediate transfer member so as to maintain a width of the grooves constant.

6. The electrophotographic image forming apparatus according to claim 5, wherein an average value of widths of the grooves is 0.5 to 2.0 μm.
